(19) United States
(12) Patent Application Publication
(10) Pub. No.: US 2014/0074402 A1
(43) Pub. Date: Mar. 13, 2014

(54) SYSTEMS AND METHODS FOR DETERMINING RISKS ASSOCIATED WITH DRIVING ROUTES

(71) Applicant: LEXISNEXIS RISK SOLUTIONS FL INC., Boca Raton, FL (US)

(72) Inventors: Ash Hassib, Acworth, GA (US); Xiaohui Lu, Bedford, MA (US); Hicham Elhassani, Roswell, GA (US)

(73) Assignee: LEXISNEXIS RISK SOLUTIONS FL INC., Boca Raton, FL (US)

(21) Appl. No.: 14/024,341

(22) Filed: Sep. 11, 2013

Related U.S. Application Data
(60) Provisional application No. 61/700,027, filed on Sep. 12, 2012.

(51) Int. Cl. G01C 21/34

(52) U.S. Cl. CPC G01C 21/3453
USPC 701/533

(57) ABSTRACT

Certain implementations of the disclosed technology may include systems, methods, and apparatus for determining risks associated with a driving route. According to an example implementation, a method is provided. The method may include identifying one or more probable routes of travel that include one or more first road segments. The method includes estimating risk associated with vehicular travel along one or more first road segments based at least in part on one or more of static road characteristics, temporal road characteristics, historical accident information, incident information, and traffic violation information associated with the one or more first road segments, and estimating risk associated with vehicular travel along the one or more probable routes by accumulating the estimated risk associated with vehicular travel along the one or more first road segments.

### TECHNICAL FIELD

This application generally relates to vehicular driving route risks, and in particular, to determining risks associated with driving routes based on static, temporal, and historical data associated with the driving route.

### BACKGROUND

Traditional automobile insurance premiums are calculated based on the risks associated with operating a particular vehicle, and on information related to the driver or drivers of the vehicle. For example, information such as make, model, and manufacture year of the vehicle may be utilized to estimate repair costs associated with various types of collisions based on parts and labor costs, etc. Information related to the driver(s) may also factor into the premium costs. For example, the premium costs may depend on driver information such as age, gender, address, driving record, etc. Such vehicle and driver risk factors may be utilized to estimate certain risks, but other factors may influence the risk associated with driving a vehicle.

### SUMMARY

Some or all of the above needs may be addressed by certain implementations of the disclosed technology. Certain implementations may include systems and methods for determining risks associated with driving routes.

Example embodiments of the disclosed technology may relate to the identification, analysis and/or assessment of risks associated with a vehicular driving route. Assessment may include processing various types of data associated with the driving route, including, but not limited to static, temporal, and/or historical data. Embodiments of the disclosed technology are particularly suited for use in a variety of technical fields including, but not limited to, road traffic safety management, highway and civil engineering, road design, urban planning, vehicle design, insurance risk assessment.

According to an example implementation, a method is provided for estimating risk associated with vehicular travel along one or more first road segments based at least in part on one or more of static road characteristics, temporal road characteristics, historical accident information, incident information, and traffic violation information associated with the one or more first road segments. The method includes estimating risk associated with vehicular travel along one or more probable routes that include the one or more first road segments by accumulating the estimated risk associated with vehicular travel along the one or more first road segments. Certain embodiments may further include identifying the one or more probable routes of travel including one or more first road segments.

According to another example implementation, a system is provided. The system includes at least one memory for storing data and computer-executable instruction, and at least one processor configured to access the at least one memory and further configured to execute the computer-executable instructions to identify one or more probable routes of travel comprising one or more first road segments, estimate risk associated with vehicular travel along one or more first road segments based at least in part on one or more of static road characteristics, temporal road characteristics, historical accident information, incident information, and traffic violation information associated with the one or more first road segments, and estimate risk associated with vehicular travel along the one or more probable routes by accumulating the estimated risk associated with vehicular travel along the one or more first road segments.

According to another example implementation of the disclosed technology, one or more computer readable media are provided. The computer readable media include computer-executable instructions that, when executed by one or more processors, cause the one or more processors to perform the method of: identifying one or more probable routes of travel comprising one or more first road segments, estimating risk associated with vehicular travel along one or more first road segments based at least in part on one or more of static road characteristics, temporal road characteristics, historical accident information, incident information, and traffic violation information associated with the one or more first road segments, and estimating risk associated with vehicular travel along the one or more probable routes by accumulating the estimated risk associated with vehicular travel along the one or more first road segments.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is an illustration depicting possible driving routes and associated road characteristics, according to an example implementation.

FIG. 2 is an illustration depicting the utilization of information from one or more second road segments to determine risks associated with one or more first road segments having similar characteristics as the one or more second road segments.

FIG. 3 is a block diagram of an illustrative system architecture, according to an example implementation of the disclosed technology.

FIG. 4 is a flow diagram of a method according to an example implementation of the disclosed technology.

### DETAILED DESCRIPTION

In the following description, numerous specific details are set forth. However, it is to be understood that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

The following illustrative embodiment relates to the calculation of risk within an insurance-related context. However, it should be noted that this context has been chosen as only one example of the many fields within which the disclosed technology can be used, as such a context is considered to be readily familiar to the reader.

Certain implementations of the disclosed technology may be utilized to determine risks associated with vehicular travel along specific driving routes. In an example implementation, a driving route may include a plurality of road segments, and each road segment may be evaluated for various risk values. For example, a road segment with a sharp turn, a history of icy conditions, and a high incidence of vehicular accidents near the turn may be assigned a relatively high risk value. On the other hand, a straight section of highway with a low average traffic volume may be assigned a relatively low risk value. According to an example implementation, the estimated risk associated with a particular driving route may be determined by accumulating the risks for the road segments that make up the driving route. Such vehicle and driver risk factors may be utilized to estimate certain risks, but other factors may influence the risk associated with driving a vehicle.

In certain example implementations, risk factors may be based on the road or route being driven along. Certain characteristics of the route itself may (positively or negatively) influence the likelihood that a collision will occur. For example, a sharp, unexpected bend in an otherwise straight road may give rise to a route segment being deemed as high risk. According to another example, a road may be liable to flooding and therefore pose a safety risk after heavy rainfall.

Certain organizations exist around the world to help prevent automobile crashes and their attendant costs, both human and financial. For example, in the United States, the National Highway Traffic Safety Administration (NHTSA) is responsible for reducing deaths, injuries and economic losses resulting from motor vehicle crashes. This is accomplished by setting and enforcing safety performance standards for motor vehicles and motor vehicle equipment, and through grants to state and local governments to enable them to conduct effective local highway safety programs. NHTSA also conducts research on driver behavior and traffic safety to develop the most efficient and effective means of bringing about safety improvements.

In Europe, the European Road Assessment Programme (EuroRAP) assesses roads to determine how to protect life in the event of a vehicular collision. EuroRAP determines safety of road infrastructure by considering characteristics such as a road's carriageway width, markings, signing, lighting, road surface and traffic management. For example, fast moving streams of traffic are considered separately from slower streams, and the provision of features, which prevent high energy collisions, such as roadside barriers are also taken into account

However, other factors and characteristics, such as time of day, season of the year, vehicle related factors (e.g. car versus bicycle, motorcycle, truck etc) and/or driver-related factors (e.g. tiredness, age, etc) may also influence the likelihood of an accident occurring for a particular vehicle operator driving on a particular section of road. Therefore, the NHTSA or EuroRAP approach is not able to provide an accurate assessment of road safety for a particular operator who is operating a particular vehicle at a particular time on a particular road.

The ability to provide a more accurate and comprehensive road safety assessment is important within a variety of technical fields, such as road safety management, civil engineering, resource planning and so on. For example, if more accurate information is available to governments, they can develop an understanding of the level of risk built into their road networks. Example embodiments of the disclosed technology may enable high risk sections of highways to be targeted for improvement. According to an example implementation of the disclosed technology, related resources may be managed and deployed more effectively. For example, emergency services resources can be placed at or near a particular section of road during certain months, times of day etc., if it can be determined that the risk of collision is higher at those times. Moreover, embodiments of the disclosed technology may provide more accurate safety information that can be provided to individual drivers in relation to particular routes and/or vehicles, and the occurrence of injuries and/or death can be reduced.

In an example implementation of the disclosed technology, the risks and risk values associated with particular road segments may be evaluated using various available and/or extrapolated information. For example, some risk values may be based on static information that is fairly consistent from day to day, such as the road segment physical layout, turns, traffic controls, etc. In another example implementation, some risk values may be based on temporal information that may vary from day to day, and from hour to hour, including weather conditions, visibility, traffic volume, etc. In yet another implementation, some risk values may be based on historical data, including but not limited to information related to traffic accidents that have happened within the particular road segment. In accordance with certain example embodiments, various combinations of the static, temporal, and historical information may be utilized to determine risks associated with vehicular travel in a road segment. Further examples of static and temporal information, for which the risks may be evaluated, will be discussed below.

According to certain example implementations of the technology, road segments may be categorized and cataloged according to similarities, and when the static, temporal, or historical information is not readily available for a particular road segment, such information may be extrapolated from other road segments having similar features. For example, a new T-intersection road segment may embody many similar static and temporal characteristics as an older T-intersection road segment in another location, but there may not be any historical accident information that has accumulated yet for association with the new T-intersection road segment. In this case, and according to an example implementation, the historical accident information associated with the older T-intersection may be utilized to estimate a projected frequency and severity of accidents that may happen at the new T-intersection, and such information may be utilized to score a risk value for the new T-intersection road segment.

Preferably, the disclosed technology provides a computer-implemented system and/or method. In certain example implementations, the disclosed technology may be considered to provide a more effective road safety method and system. Additionally or alternatively, it may be considered to provide an enhanced data processing solution which provides a more accurate assessment of route-related risks. Such an improved result can be used to advantage within a variety of contexts. Additionally or alternatively, it may be considered that the disclosed technology may be configured to receive data relating to a variety of factors and intelligently process that data to provide an improved understanding and/or prediction of vehicle-related incidents. Additionally or alternatively, it may be considered that the disclosed technology provides an improved method or system for modeling road safety performance based upon a data received from a variety of sources and/or relating to a variety of influencing factors. Additionally or alternatively, certain embodiments of the disclosed technology may provide a solution for identifying the road-safety risks of more than one vehicular route, comparing the identified risks, and selecting one of the plurality of routes as preferable or recommended for use (e.g. likely to be safer than the non-selected routes).

Some implementations of the disclosed technology will be described more fully hereinafter with reference to the accompanying drawings. This disclosed technology may, however, be embodied in many different forms and should not be construed as limited to the implementations set forth herein.

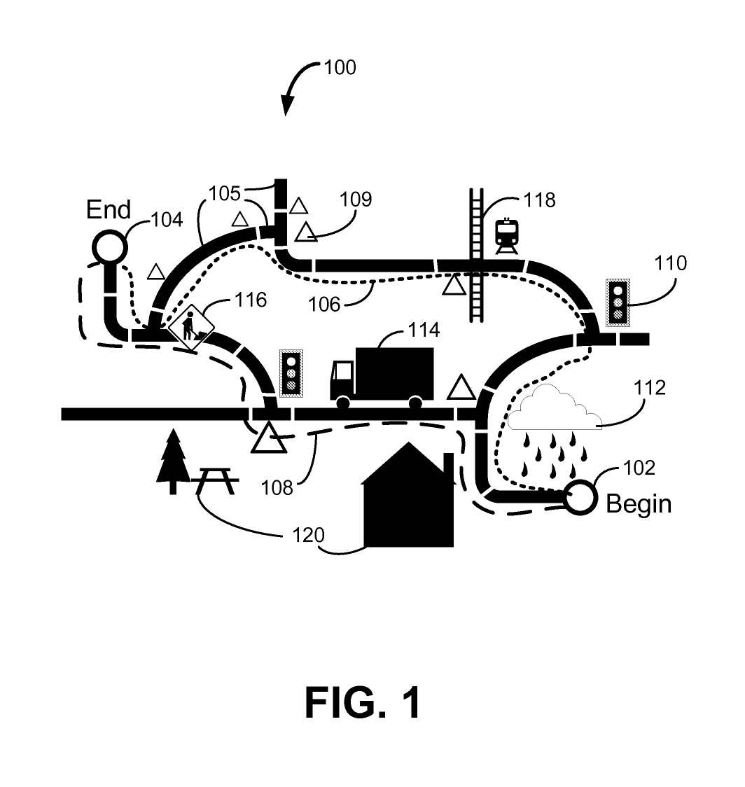

FIG. 1 is an illustration 100 depicting possible driving routes and associated road characteristics, according to an example implementation. In an example implementation, a beginning location 102 and an ending location 104 may be known for a particular driver. For example, the beginning location 102 may correspond to a home address of the driver, and the ending location 104 may correspond to a work address for the driver. As depicted in FIG. 1, there may be possible driving routes 106, 108 for travelling from the beginning location 102 to the ending location 104. Each one of the driving routes 106, 108 may include a plurality of road segments 105, and each of the road segments 105 may be associated with various road characteristics. For example, certain road segments 105 may be associated with historical accident information 109. In other example embodiments, certain road segments may be associated with characteristics that may enable assignment of risk values to the road segments. Such characteristics may include traffic controls 110, weather patterns 112, traffic volume 114, construction 116, train crossings 118, nearby points of interest 120, etc.

In accordance with certain example embodiments of the disclosed technology, road characteristic information may be categorized as static, temporal, or historical. Static information associated with a road segment may include, but is not limited to, the physical layout of individual road segments, types, detailed physical characteristics, materials, nearby points of interest, feature density, etc. For example, a road segment may be designated as a state highway, an interstate, a county road, etc. The road segment may be further characterized as rural or urban. The road segment may be further characterized as a toll road, a tunnel, a paved road, a dirt road, a gravel road, etc. According to certain example embodiments, static information such as detailed physical characteristics of a road segment may also be utilized, including, but not limited to road direction, height, curve and slope. Static information may further include intersections, exits, entries, crossroads, roundabouts, nearby points of attraction, etc. According to an example implementation of the disclosed technology, static information may include surface conditions, lane types, lane forming, lane ending, traffic controls, painted lines, speed limits, average traffic patterns, average speed, etc.

In accordance with certain example embodiments of the disclosed technology, temporal information associated with a road segment may include, but is not limited to, time-varying traffic patterns, traffic density, lighting conditions, temporary construction, etc. for example. Additionally, and without limitation, temporal road characteristics, can include time-of-day, lighting and weather conditions, visibility, traffic signals, (i.e., temporal signals from traffic control devices, traffic volume, traffic speed, traffic management and enforcement activities, emergency vehicle operations, road or road-related work, road or lane closures and detours, local events, accidents and incidents, activities of non-automotive vehicles and pedestrians on the road, distractions and obstructions, etc. As used herein, temporal characteristics may vary with time of the day, day of the week, etc. According to an example implementation of the disclosed technology, certain temporal characteristics may be averaged and categorized as static characteristics for assigning certain risks to road segments.

According to certain example embodiments of the disclosed technology, historical information may be utilized for determining risks associated with driving on particular road segments. For example, police reports, accident reports, vehicular collision insurance claims, extreme weather history, and the like may provide an indication of future accident risks.

According to certain example embodiments of the disclosed technology, a plurality of different driving routes 106, 108 may be possible, for example as shown in FIG. 1 between a beginning location 102 and an ending location 104. One example embodiment of the disclosed technology may be utilized to calculate overall risks associated with the possible driving routes 106, 108 based on the accumulation of risk of associated road segments 105 along the driving routes 106, 108. Such information may be provided to a driver, for example to educate or incentivize the driver to travel the safer route.

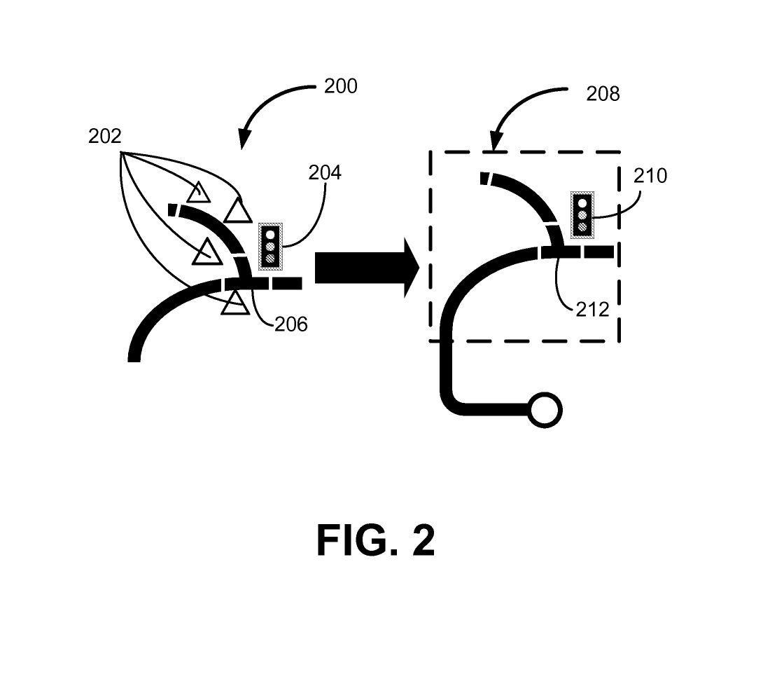

FIG. 2 is an illustration depicting the utilization of information from one or more second road segments 200 to determine risks associated with one or more first road segments 208 having similar characteristics as the one or more second road segments 200. For example, one or more first road segments 208 may include new construction of a T-intersection road segment 212 and a three-way stop light 210. In an example implementation, an estimate of likely future accidents at or near the T-intersection road segment 212 may be determined by searching a database for accident reports 202 associated with a similar T-intersection road segment 206 having a similar three-way stop light 204. This example is for illustration purposes and may be utilized for other road segment configurations and risk characteristics. In certain example embodiments, the surrounding road segments may be used as factors in determining the risk values or confidence values. For example, a selected group comprising one or more first road segments 208 may be compared with a similar selected group comprising one or more second road segments 200, but additional connecting road segments may have an influence on the accident rate at the segment of interest. For example, long straight road segment connected to a sharp turn segment may have a higher associated accident rate compared with short winding segment connected to a similar sharp turn segment.

According to an example implementation of the disclosed technology, risk associated with a specific road segment may be based on the insurance losses sustained from accidents that have occurred on the road segments of similar characteristics. In certain embodiments, the location of the accident may be derived from police reports, or other similar records containing accident addresses. In certain example embodiments, the location of an accident may be assigned to a road segment based on longitude and latitude coordinates.

According to certain example embodiments, an accident may be linked with insurance loss based on the characteristics of the people involved, for example, name, driver license number, etc. According to certain example embodiments, an accident may be linked with insurance loss based on the characteristics of the vehicle involved in an accident by, for example, license plate number, make, model, year, vehicle identification number, etc.

According to certain example implementation of the disclosed technology, insurance losses may be correlated with different coverage types (for example, bodily injury, property damage, etc.,) of a linked accident to the characteristics of the road segment to which the location of the accident is assigned, via an appropriate modeling method, such as Generalized Linear Models (GLMs). In accordance with an example implementation of the disclosed technology expected insurance losses or other potential risks associated with driving on a particular road segment may be determined by insurance coverage types. For example, this may be accomplished by applying the identified correlations between insurance losses and characteristics of a road segment to the specific characteristics of the given road segment.

In a certain example implementation, potential road segments may be stored in a database and linked with risks corresponding to these road segments. In certain example implementations, road segments and corresponding risks may be searched for and retrieved from the database. In another example implementation, road segments may be categorized by type or characteristic, and may be searchable based on the type or characteristic.

According to an example implementation of the disclosed technology, road segments within a given radius of an address, or within a pre-defined boundary (e.g. ZIP code) may be identified. In accordance with an example embodiment, an overall risk associated with all the road segments within the specified range may be determined.

As disclosed herein, information about the driver or the vehicle may not necessarily be required to determine the risks associated with a driving route, but rather, the static, temporal, physical, and historical information about the driving route may be utilized to determine certain risks.

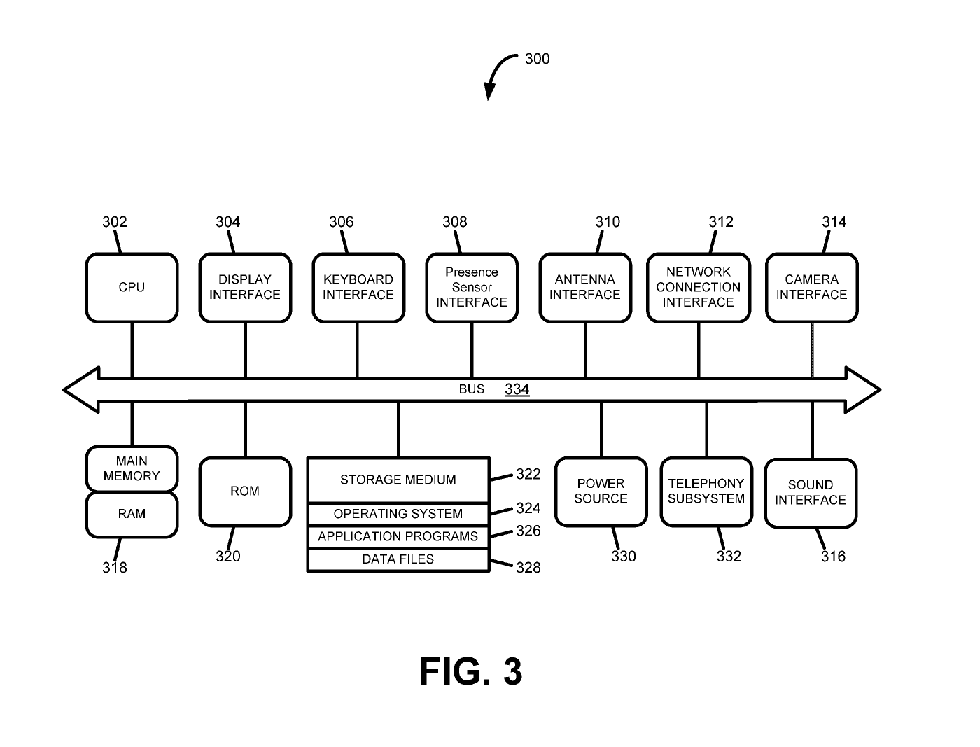

Various embodiments of the communication systems and methods herein may be embodied in non-transitory computer readable media for execution by a processor. An exemplary embodiment may be used in an application of a mobile computing device, such as a smartphone or tablet, but other computing devices may also be used. FIG. 3 illustrates schematic diagram of internal architecture of an exemplary mobile computing device 300. It will be understood that the architecture illustrated in FIG. 3 is provided for exemplary purposes only and does not limit the scope of the various embodiments of the communication systems and methods.

FIG. 3 depicts a block diagram of an illustrative computer system architecture 300 according to an exemplary embodiment of the disclosed technology. Certain aspects of FIG. 3 may also be embodied in the controller 202, as shown in FIG. 2. Various embodiments of the communication systems and methods herein may be embodied in non-transitory computer readable media for execution by a processor. It will be understood that the architecture illustrated in FIG. 3 is provided for exemplary purposes only and does not limit the scope of the various embodiments of the communication systems and methods.

The architecture 300 of FIG. 3 includes a central processing unit (CPU) 302, where computer instructions are processed; a display interface 304 that acts as a communication interface and provides functions for rendering video, graphics, images, and texts on the display; a keyboard interface 306 that provides a communication interface to a keyboard; and a pointing device interface 308 that provides a communication interface to a pointing device or touch screen. Exemplary embodiments of the architecture 300 may include an antenna interface 310 that provides a communication interface to an antenna; a network connection interface 312 that provides a communication interface to a network. In certain embodiments, a camera interface 314 is provided that acts as a communication interface and provides functions for capturing digital images from a camera. In certain embodiments, a sound interface 316 is provided as a communication interface for converting sound into electrical signals using a microphone and for converting electrical signals into sound using a speaker. According to exemplary embodiments, a random access memory (RAM) 318 is provided, where computer instructions and data are stored in a volatile memory device for processing by the CPU 302.

According to an exemplary embodiment, the architecture 300 includes a read-only memory (ROM) 320 where invariant low-level systems code or data for basic system functions such as basic input and output (I/O), startup, or reception of keystrokes from a keyboard are stored in a non-volatile memory device. According to an exemplary embodiment, the architecture 300 includes a storage medium 322 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 324, application programs 326 (including, for example, a web browser application, a widget or gadget engine, and or other applications, as necessary) and data files 328 are stored. According to an exemplary embodiment, the architecture 300 includes a power source 330 that provides an appropriate alternating current (AC) or direct current (DC) to power components. According to an exemplary embodiment, the architecture 300 includes and a telephony subsystem 332 that allows the device 300 to transmit and receive sound over a telephone network. The constituent devices and the CPU 302 communicate with each other over a bus 334.

In accordance with exemplary embodiments, the CPU 302 has appropriate structure to be a computer processor. In one arrangement, the computer CPU 302 is more than one processing unit. The RAM 318 interfaces with the computer bus 334 to provide quick RAM storage to the CPU 302 during the execution of software programs such as the operating system application programs, and device drivers. More specifically, the CPU 302 loads computer-executable process steps from the storage medium 322 or other media into a field of the RAM 318 in order to execute software programs. Data is stored in the RAM 318, where the data is accessed by the computer CPU 302 during execution. In one exemplary configuration, the device 300 includes at least 128 MB of RAM, and 256 MB of flash memory.

The storage medium 322 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the device 300 to access computer-executable process steps, application programs and the like, stored on removable and non-removable memory media, to off-load data from the device 300 or to upload data onto the device 300. A computer program product, such as one utilizing a communication system may be tangibly embodied in storage medium 322, which may comprise a machine-readable storage medium.

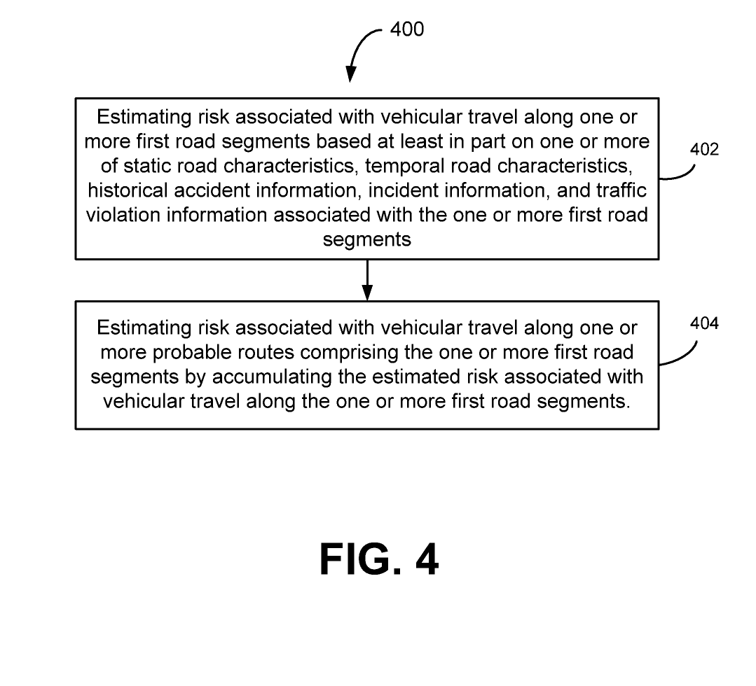

An example method 400 for estimating risk associated with vehicular travel along one or more probable routes will now be described with reference to the flowchart of FIG. 4. The method 400 starts in block 402, and according to an example implementation includes estimating risk associated with vehicular travel along one or more first road segments based at least in part on one or more of static road characteristics, temporal road characteristics, historical accident information, incident information, and traffic violation information associated with the one or more first road segments. In block 404, the method 400 includes estimating risk associated with vehicular travel along one or more probable routes comprising the one or more first road segments by accumulating the estimated risk associated with vehicular travel along the one or more first road segments.

According to an example embodiment, incident information may include information that indicates a risk factor. For example, incident information may be related to a vehicle skidding on an icy road that did not end up as a crash. In one example implementation, the incident could be captured by a traffic camera, or noted by a police officer near the scene of the incident.

According to an example implementation of the disclosed technology, estimating the risk associated with vehicular travel along the one or more first road segments may be based on information related to accidents that have occurred on second road segments having road characteristics substantially equal to road characteristics of the one or more first road segments.

In certain example implementations, static road characteristics may include one or more of road types, cultural and conventional characteristics, administrative characteristics, geographical characteristics, physical characteristics, traffic monitoring and control characteristics, weather patterns, traffic patterns, and surrounding points of interest.

In certain example implementations, temporal road characteristics may include one or more of time, lighting and weather conditions, visibility, traffic signals, traffic volume, traffic speed, traffic management and enforcement activities, emergency vehicle operations, road or road-related work, road or lane closures and detours, local events, accidents and incidents, activities of non-automotive vehicles and pedestrians on the road, distractions and obstructions.

In certain example implementations, historical accident information may include one or more of time-of-day, location, parties involved, costs of incident-related property damages and bodily injuries, payment toward incident-related property damages and bodily injuries, details of accidents, penalty associated with an accident-related violation, insurance claims handling process, details of how the incident is conducted, captured, documented, handled, and its associated disputes resolved, and static and temporal road characteristics at the time of one or more previous accidents.

Example embodiments may include identifying the one or more probable routes of travel based at least in part on one or more of: a start address, an end address, one or more location coordinates, and a one or more route descriptors. For example, a route descriptor may include a description of the route such as an intersection, a business along the route, an address, or any identifying feature that may be associated with a route or a segment of a route.

In accordance with an example implementation of the disclosed technology, estimating the risk associated with vehicular travel along the one or more first road segments may be based on standardized and/or normalized risk data information. For example, such information may be derived from nationwide road risk data in which each road segment is represented by a normalized risk score. In certain example implementations, the standardized and/or normalized risk data information may utilize information from each analyzed road segment, and each segment may be ranked according to various risk factors, which may include static, temporal, and/or historical information. For example, the standardized and/or normalized risk data information may vary with temporal conditions, such as weather. As an illustration, consider certain mountain passes that may be relatively safe for travel in the summer time may be extremely dangerous in the wintertime, particularly during and after snowstorms. Thus, according to an example implementation of the disclosed technology, the standardized and/or normalized risk data information may be ranked periodically (for example, every hour, etc.) to account for changing road conditions, construction, traffic density, weather, visibility, traffic patterns, time of day, etc.

According to an example implementation of the disclosed technology, estimating the risk associated with vehicular travel along the one or more road segments is further based on information related to accidents that have occurred on second road segments having road characteristics substantially equal to road characteristics of the one or more first road segments. In certain example implementations, static road characteristics include one or more of road types, cultural and conventional characteristics, administrative characteristics, geographical characteristics, physical characteristics, traffic monitoring and control characteristics, weather patterns, traffic patterns, and surrounding points of interest. For example, traffic monitoring and control characteristics may include regions having traffic cameras or known hiding spots by police officers.

In an example implementation, cultural and conventional characteristics, for example, may be indicative that a certain road or road segment is designated as a scenic road. In another example implementation, the cultural and conventional characteristics may be indicative that a certain road or road segment is used heavily by religious practitioners. In certain example implementations, the administrative characteristics may include (but are not limited to) information such as, for example, a certain road is a toll road. In another example implementation, administrative characteristics may be indicative that a certain road or road segment has a certain speed limit. In certain example implementations, the geographical characteristics may include (but are not limited to) information such as location, elevation, slope, etc.

In certain example implementations, temporal road characteristics include one or more of time, lighting and weather conditions, visibility, traffic volume, traffic speed, distractions and obstructions.

In certain example implementations, historical accident information comprises one or more of time, location, costs of accident-related property damages, bodily injuries, and static and temporal road characteristics at the time of one or more previous accidents.

According to an example implementation of the disclosed technology, accumulating the estimated risk R associated with probable route includes determining a risk value associated with each segment q in the route. In one implementation, the risk R for each segment q may be determined according to the equation:

$${R}_{{segment}_{q}} = {\sum }_{i}^{L} {w}_{i} {S}_{i} + {\sum }_{j}^{M} {w}_{j} {T}_{j} + {\sum }_{k}^{N} {w}_{k} {A}_{k} ,$$

wherein each of L static road characteristics S and associated weightings w are represented by wᵢSᵢ, each of M temporal road characteristics T and associated weightings w are represented by wⱼTⱼ, and each of N historical accident information A and associated weightings w are represented by wₖAₖ. In the general sense, each segment q may be scored as a function ƒ of static road characteristics S, temporal road characteristics T, and historical accident information A, Rsegment_{q}=ƒ(S, T, A). According to an example implementation the overall risk score R associated with a particular route may be determined by summing the risks associated with each segment that makes up the route, for example:

$${R}_{route} = {\sum }_{q}^{ } {R}_{{segment}_{q} .}$$

According to an example implementation, the segment risk score may be represented and/or determined by employing a log linked Poisson function to express of the various segment static, temporal, and historical factors according to the equation:

$${R}_{{segment}_{q}} = C * exp ( {\sum }_{i}^{L} {w}_{i} {S}_{i} + {\sum }_{j}^{M} {w}_{j} {T}_{j} + {\sum }_{k}^{N} {w}_{k} {A}_{k} )$$

where C is a constant and the overall risk score R associated with a particular route may be determined by summing the risks associated with each segment, as shown above.

According to another example implementation, the segment risk score may be represented and/or determined by employing a logit linked Binomial function, utilizing the various segment static, temporal, and historical factors according to the equation:

$${R}_{{segment}_{q}} = \frac{C * exp ( {\sum }_{i}^{ } {w}_{i} \cdot {S}_{i} + {\sum }_{j}^{ } {w}_{j} \cdot {T}_{j} + {\sum }_{k}^{ } {w}_{k} \cdot {A}_{k} )}{1 + C * exp ( {\sum }_{i}^{ } {w}_{i} \cdot {S}_{i} + {\sum }_{j}^{ } {w}_{j} \cdot {T}_{j} + {\sum }_{k}^{ } {w}_{k} \cdot {A}_{k} )} ,$$

where C is a constant and the overall risk score R associated with a particular route may be determined by summing the risks associated with each segment, as shown above.

Certain example implementations may include determining a plurality of possible routes of travel between the start address and the end address and identifying a route with minimum estimated risk.

According to example implementations, certain technical effects can be provided, such as creating certain systems and methods that provide enhanced risk assessment for specific routes of vehicular travel. Example implementations of the disclosed technology can provide the further technical effects of providing systems and methods for risk assessment based on empirical data that may include physical, static, temporary, and/or historical information regarding road segments that are utilized in travel along a particular route. Example implementations of the disclosed technology can provide the further technical effects of estimating risk associated with vehicular travel along the one or more road segments based on information related to accidents that have occurred on second road segments having road characteristics similar or substantially equal to road characteristics of the one or more first road segments.

In example implementations of the disclosed technology, the system architecture 300 may include any number of hardware and/or software applications that are executed to facilitate any of the operations. In example implementations, one or more I/O interfaces may facilitate communication between the system architecture 300 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the system architecture 300. The one or more I/O interfaces may be utilized to receive or collect data and/or user instructions from a wide variety of input devices. Received data may be processed by one or more computer processors as desired in various implementations of the disclosed technology and/or stored in one or more memory devices.

One or more network interfaces may facilitate connection of the system architecture 300 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

As desired, implementations of the disclosed technology may include the system architecture 300 with more or less of the components illustrated in FIG. 3.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method comprising:
estimating risk associated with vehicular travel along one or more first road segments based at least in part on one or more of static road characteristics, temporal road characteristics, historical accident information, incident information, and traffic violation information associated with the one or more first road segments; and
estimating risk associated with vehicular travel along one or more probable routes comprising the one or more first road segments by accumulating the estimated risk associated with vehicular travel along the one or more first road segments.

2. The method of claim 1, further comprising identifying the one or more probable routes of travel based at least in part on one or more of: a start address, an end address, one or more location coordinates, and a one or more route descriptors.

3. The method of claim 1, wherein estimating the risk associated with vehicular travel along the one or more first road segments is further based on information related to accidents that have occurred on second road segments having road characteristics substantially equal to road characteristics of the one or more first road segments.

4. The method of claim 1, wherein estimating the risk associated with vehicular travel along the one or more first road segments is further based on standardized and normalized risk data information.

5. The method of claim 1, wherein static road characteristics include one or more of road types, cultural and conventional characteristics, administrative characteristics, geographical characteristics, physical characteristics, traffic monitoring and control characteristics, weather patterns, traffic patterns, and surrounding points of interest.

6. The method of claim 1, wherein temporal road characteristics include one or more of time, lighting and weather conditions, visibility, traffic signals, traffic volume, traffic speed, traffic management and enforcement activities, emergency vehicle operations, road or road-related work, road or lane closures and detours, local events, accidents and incidents, activities of non-automotive vehicles and pedestrians on the road, distractions and obstructions.

7. The method of claim 1, wherein the historical accident information comprises one or more of time-of-day, location, parties involved, costs of incident-related property damages and bodily injuries, payment toward incident-related property damages and bodily injuries, details of accidents, penalty associated with an accident-related violation, insurance claims handling process, details of how the incident is conducted, captured, documented, handled, and its associated disputes resolved, and static and temporal road characteristics at the time of one or more previous accidents.

8. The method of claim 1, wherein accumulating the estimated risk associated with probable route comprises determining a risk value associated with each segment q in the route according to the equation:
$${R}_{{segment}_{q}} = f ( {\sum }_{i}^{L} {w}_{i} {S}_{i} + {\sum }_{j}^{M} {w}_{j} {T}_{j} + {\sum }_{k}^{N} {w}_{k} {A}_{k} ) ,$$
and summing the risk value for each segment in the route according to the equation:
$${R}_{route} = {\sum }_{q}^{ } {R}_{{segment}_{q} ,}$$
wherein ƒ is a function and each of L static road characteristics S and associated weightings w are represented by wᵢSᵢ, each of M temporal road characteristics T and associated weightings w are represented by wⱼTⱼ, and each of N historical accident information A and associated weightings w are represented by wₖAₖ.

9. The method of claim 1, further comprising estimating risk associated with vehicular travel along one or more probable routes having a minimum estimated risk.

10. A system comprising:
at least one memory for storing data and computer-executable instructions; and
at least one processor configured to access the at least one memory and further configured to execute the computer-executable instructions to:
identify one or more probable routes of travel, the one or more probable routes of travel comprising one or more first road segments;
estimate risk associated with vehicular travel along one or more first road segments based at least in part on one or more of static road characteristics, temporal road characteristics, historical accident information, incident information, and traffic violation information associated with the one or more first road segments; and
estimate risk associated with vehicular travel along the one or more probable routes by accumulating the estimated risk associated with vehicular travel along the one or more first road segments.

11. The system of claim 10, wherein the at least one processor is configured to access the at least one memory and further configured to execute the computer-executable instructions to identify one or more probable routes of travel is based at least in part on one or more of: a start address, an end address, one or more location coordinates, and a one or more route descriptors.

12. The system of claim 10, wherein the risk associated with vehicular travel along the one or more first road segments is further estimated based on information related to accidents that have occurred on second road segments having road characteristics substantially equal to road characteristics of the one or more first road segments.

13. The system of claim 10, wherein the risk associated with vehicular travel along the one or more first road segments is further estimated based on standardized and normalized risk data information.

14. The system of claim 10, wherein static road characteristics include one or more of road types, physical characteristics, traffic control, weather patterns, traffic patterns, and surrounding points of interest.

15. The system of claim 10, wherein temporal road characteristics include one or more of time, lighting and weather conditions, visibility, traffic signals, traffic volume, traffic speed, traffic management and enforcement activities, emergency vehicle operations, road or road-related work, road or lane closures and detours, local events, accidents and incidents, activities of non-automotive vehicles and pedestrians on the road, distractions and obstructions.

16. The system of claim 10, wherein the historical accident information comprises one or more of time-of-day, location, parties involved, costs of incident-related property damages and bodily injuries, payment toward incident-related property damages and bodily injuries, details of accidents, penalty associated with an accident-related violation, insurance claims handling process, details of how the incident is conducted, captured, documented, handled, and its associated disputes resolved, and static and temporal road characteristics at the time of one or more previous accidents.

17. The system of claim 10, wherein the at least one processor is configured to compute the estimated risk associated with probable route by determining a risk value associated with each segment q in the route according to the equation:
$${R}_{{segment}_{q}} = f ( {\sum }_{i}^{L} {w}_{i} {S}_{i} + {\sum }_{j}^{M} {w}_{j} {T}_{j} + {\sum }_{k}^{N} {w}_{k} {A}_{k} ) ,$$
and summing the risk value for each segment in the route according to the equation:
$${R}_{route} = {\sum }_{q}^{ } {R}_{{segment}_{q} ,}$$
wherein ƒ is a function and each of L static road characteristics S and associated weightings w are represented by wᵢSᵢ, each of M temporal road characteristics T and associated weightings w are represented by wⱼTⱼ, and each of N historical accident information A and associated weightings w are represented by wₖAₖ.

18. The system of claim 10, wherein the at least one processor is further configured to compute a plurality of possible routes of travel between the start address and the end address and identify a route with minimum estimated risk.

19. One or more computer readable media comprising computer-executable instructions that, when executed by one or more processors, cause the one or more processors to perform the method of:
identifying one or more probable routes of travel comprising one or more first road segments;
estimating risk associated with vehicular travel along one or more first road segments based at least in part on one or more of static road characteristics, temporal road characteristics, historical accident information, incident information, and traffic violation information associated with the one or more first road segments; and
estimating risk associated with vehicular travel along the one or more probable routes by accumulating the estimated risk associated with vehicular travel along the one or more first road segments.

20. The computer readable media of claim 19, wherein estimating the risk associated with vehicular travel along the one or more first road segments is further based on information related to accidents that have occurred on second road segments having road characteristics substantially equal to road characteristics of the one or more first road segments.

21. The computer readable media of claim 19, wherein static road characteristics include one or more of road types, cultural and conventional characteristics, administrative characteristics, geographical characteristics, physical characteristics, traffic monitoring and control characteristics, weather patterns, traffic patterns, and surrounding points of interest, and wherein temporal road characteristics include one or more of time, lighting and weather conditions, visibility, traffic signals, traffic volume, traffic speed, traffic management and enforcement activities, emergency vehicle operations, road or road-related work, road or lane closures and detours, local events, accidents and incidents, activities of non-automotive vehicles and pedestrians on the road, distractions and obstructions.

22. The computer readable media of claim 19, wherein the historical accident information comprises one or more of time-of-day, location, parties involved, costs of incident-related property damages and bodily injuries, payment toward incident-related property damages and bodily injuries, details of accidents, penalty associated with an accident-related violation, insurance claims handling process, details of how the incident is conducted, captured, documented, handled, and its associated disputes resolved, and static and temporal road characteristics at the time of one or more previous accidents.

23. The computer readable media of claim 19, wherein accumulating the estimated risk associated with probable route comprises determining a risk value associated with each segment q in the route according to the equation:
$${R}_{{segment}_{q}} = f ( {\sum }_{i}^{L} {w}_{i} {S}_{i} + {\sum }_{j}^{M} {w}_{j} {T}_{j} + {\sum }_{k}^{N} {w}_{k} {A}_{k} ) ,$$
and summing the risk value for each segment in the route according to the equation:
$${R}_{route} = {\sum }_{q}^{ } {R}_{{segment}_{q} ,}$$
wherein ƒ is a function and each of L static road characteristics S and associated weightings w are represented by wᵢSᵢ, each of M temporal road characteristics T and associated weightings w are represented by wⱼTⱼ, and each of N historical accident information A and associated weightings w are represented by wₖAₖ.

24. The computer readable media of claim 19, further comprising determining a plurality of possible routes of travel between the start address and the end address and identifying a route with minimum estimated risk.
